(19) United States
(12) Patent Application Publication
(10) Pub. No.: US 2015/0174957 A1
(43) Pub. Date: Jun. 25, 2015

(54) CASTER SUSPENSION SYSTEM

(71) Applicant: Altoz, Inc, Greenbush, MN (US)

(72) Inventors: Dennis Brazier, Greenbush, MN (US); Mark Reese, Roseau, MN (US)

(21) Appl. No.: 14/137,646

(22) Filed: Dec. 20, 2013

(51) Int. Cl. B60B 33/04

(52) U.S. Cl. CPC B60B 33/045

(57) ABSTRACT

A caster assembly incorporating a shock absorber is disclosed including an upper mount defining a vertical spindle axis for mounting to a movable structure. A lower mount is rigidly and pivotally mounted to the upper mount and rotatable about a pivot axis. A wheel is pivotally secured to the lower mount. A resilient member is positioned between the upper mount and the lower mount. The upper and lower mounts include first and second opposed plates having the resilient member positioned therebetween. Pivotal coupling is accomplished between flanges extending from the plates. The lower mount may include a third plate having flanges extending downwardly therefrom pivotally secured to the wheel.

### FIELD OF THE INVENTION

This application relates to a caster assembly, such as a caster assembly for supporting a chassis of a mower.

### BACKGROUND OF THE INVENTION

Many devices make use of casters to enable rolling movement. As known in the art, a caster typically includes a wheel secured to a swiveling mount. The wheel is therefore allowed to swivel in response to an urging force. Due to their small size and simplicity, caster wheels have many applications. One common application of casters is to support the chassis of lawnmowers from small riding mowers to large industrial lawnmowers. Casters are well suited to this application since the mower frame requires support but must also be able to follow steering inputs to the steered wheels of the lawnmower.

However, the use of casters in lawnmowers often strains their capacity to function. In particular, the driven and/or steered wheels of the lawnmower may be coupled to a suspension system. Likewise, the driver's seat may have its own suspension system. In contrast, the casters are subject to the same bumps as the other wheels but typically do not have any sort of suspension. This increases cyclic stress on the caster, lawnmower deck, and other structures. Vibrations transmitted from the casters also increase the discomfort of the driver.

Various attempts have been made to provide suspensions for casters in lawnmowers and other applications. This application discloses an improved caster suspensions that are both compact and inexpensive to manufacture.

### SUMMARY OF THE INVENTION

In one aspect of the invention, a caster assembly includes an upper mount defining a spindle axis oriented substantially vertically, the upper mount configured to rotatably mount to a movable structure, such as the chassis of the mower, specifically the arms that extend from the main chassis. A lower mount is rigidly and pivotally mounted to the upper mount and rotatable about a pivot axis, the pivot axis being substantially perpendicular to the spindle axis. A wheel is pivotally secured to the lower mount and rotatable about a wheel axis, the wheel axis being offset from the spindle axis along a longitudinal direction perpendicular to the spindle axis and the wheel axis. A resilient member is positioned between the upper mount and the lower mount.

The wheel axis may be parallel to the pivot axis. The pivot axis may also be offset from the spindle axis along the longitudinal direction. For example, the pivot axis may be offset from the spindle axis along the longitudinal direction such that the spindle axis is positioned between the pivot axis and the wheel axis. The wheel axis may be offset from the spindle axis a greater amount than the pivot axis.

In another aspect of the invention, the upper mount includes a first plate having first flanges extending downwardly therefrom and the lower mount includes a second plate oriented substantially parallel to the first plate when the resilient member is undeformed. The second plate has second flanges extending upwardly therefrom, the first flanges being pivotally connected to the second flanges. The resilient member may be fastened to the first or second plate or simply retained between the plates. The lower mount may include a third plate having third flanges extending downwardly therefrom, the third plate being fastened to the second plate and the wheel being pivotally secured between the two flanges.

### BRIEF DESCRIPTION OF THE DRAWINGS

Preferred and alternative examples of the present invention are described in detail below with reference to the following drawings:

FIG. 1A is an isometric view of a caster assembly in accordance with an embodiment of the present invention;

FIG. 1B is a side elevation view of the caster assembly of FIG. 1A;

FIG. 2 is an exploded view of a caster assembly in accordance with an embodiment of the present invention;

FIGS. 3A and 3B are cross-sectional views of a caster assembly in accordance with an embodiment of the present invention;

FIG. 4 is an isometric view of a lawnmower incorporating a caster assembly in accordance with an embodiment of the present invention;

FIGS. 5A and 5B are cross-sectional views of a pad for use in a caster assembly in accordance with an embodiment of the present invention;

FIGS. 6A and 6B are cross-sectional views of another pad for use in a caster assembly in accordance with an embodiment of the present invention;

FIGS. 7A and 7B are cross-sectional views of yet another pad for use in a caster assembly in accordance with an embodiment of the present invention; and

FIG. 8 is a side elevation view of a caster assembly incorporating a spring and shock absorber in accordance with an embodiment of the present invention.

### DETAILED DESCRIPTION OF THE PREFERRED EMBODIMENT

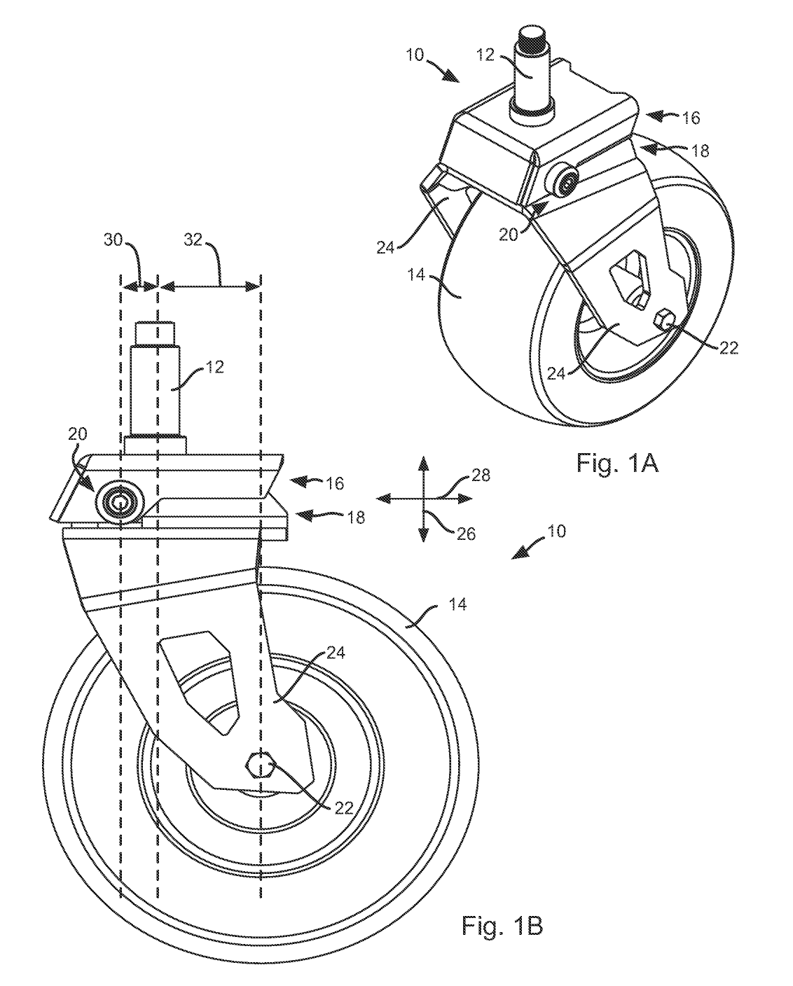

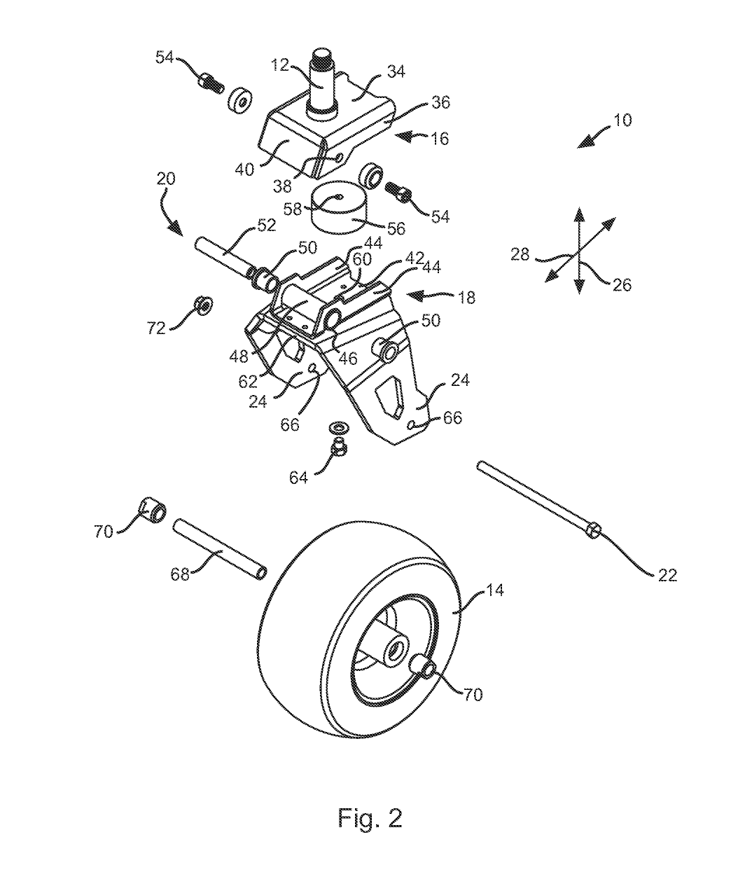

Referring to FIGS. 1A and 1B, a caster assembly 10 may include a spindle 12 for rotatably mounting the caster assembly 10 to a movable structure, such as a deck of a mower or other device. Alternatively, the caster assembly 10 may define an aperture or other structure for receiving a spindle secured to the movable structure. The spindle 12 may be secured by any means to the chassis or its components, such as by threads, a snap ring, or other means.

The caster assembly 10 further includes a wheel 14. The wheel 14 is coupled to the spindle 12 by means of an upper mount 16 to which the spindle 12 is mounted and a lower mount 18 to which the wheel 14 rotatably secures. A pivot 20 rigidly and pivotally secures the upper mount 16 to the lower mount 18. Rigid and pivotal securement may include securement that allows pivoting movement but otherwise maintains the upper and lower mount 18 in fixed relation to one another within the limits of manufacturing tolerances. The wheel 14 rotates about an axle 22 that may secure to the lower mount 18 by securing to flanges 24 extending downwardly from the lower mount 18.

Referring specifically to FIG. 1B, the spindle 12 may define an axis of rotation extending in a vertical direction 26. The caster assembly 10 may further define a longitudinal direction 28 substantially perpendicular to the vertical direction 26 and to an axis of rotation of the pivot 20. The wheel axle 22 further defines an axis of rotation that is substantially parallel to the axis of rotation of the pivot 20. For purposes of this disclosure “substantially” parallel or perpendicular may include within 15 degrees, preferably within 5 degrees, of parallel or perpendicular, respectively.

As shown in FIG. 1B, in the preferred embodiment, the axis of rotation of the pivot 20 is offset from the axis of rotation of the spindle 12 by a distance 30 along the longitudinal direction 26. Likewise, the axis of rotation of the wheel 14 is offset from the axis of rotation of the spindle 12 by an amount 32 along the longitudinal direction 26. The distance 32 may be larger than the distance 30, such as between 25 and 500 percent greater. In some embodiments, the distance 30 is greater than the distance 32. In still other embodiments, the pivot 20 and axle 22 are both located on the same side of the axis of rotation of the spindle 12. In alternate embodiments, pivot 20 may be aligned with the axis of rotation of spindle 12 or may be between the axis of rotation of spindle 12 and axle 22.

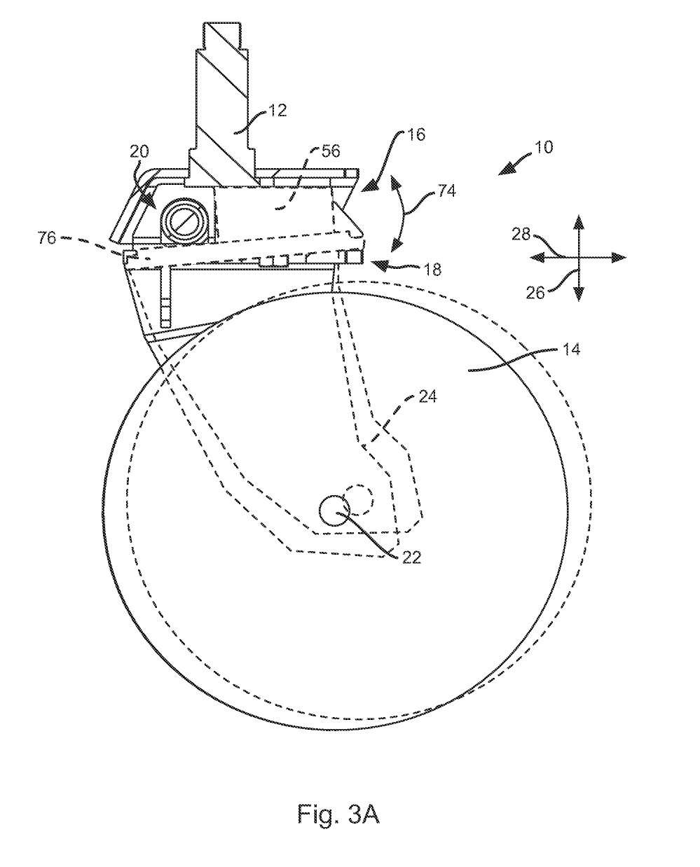

FIG. 2 illustrates an example implementation of the caster assembly 10 of FIGS. 1A and 1B. The upper mount 16 may include a center plate 34 having flanges 36 extending downwardly from the plate 34. The flanges 36 may be substantially parallel to the longitudinal direction 28. The flanges 36 may further define apertures 38 for defining the pivot 20 (shown in FIGS. 1A and 1B). A stop flange 40 may also extend downwardly from the center plate 34. The stop may be operable to prevent the lower mount 18 from rotating about the pivot 20 past a predetermined angular position. In the illustrated embodiment, the stop flange 40 extends substantially parallel to the axis of rotation of the pivot 20. For example, the stop flange 40 may secure to a forward edge of the plate 34. The stop flange 40 may also be angled, e.g. extend horizontally outwardly from the plate 34 a distance, then angle downwardly. However, other configurations of the stop flange 40 that prevent rotation of the lower mount 18 past the predetermined angular position may also be used.

The lower mount 18 may include a center plate 42 having flanges 44 extending upwardly therefrom. Alternatively the plate may have flanges extending downwardly or no flanges. In the illustrated embodiment, the plate 34 and plate 42 oppose each other. In some embodiments, the plate 34 and plate 42 may also be oriented horizontally when the caster assembly 10 and the movable structure to which it is mounted are resting on a horizontal surface. The flanges 44 may be offset from one another and sized to fit between the flanges 36. Alternatively, the flanges 36 are offset from one another and sized to fit between the flanges 44. The flanges 44 may also be oriented substantially parallel to the longitudinal direction 28. The flanges may alternatively be otherwise oriented to provide any necessary structural strength.

In some embodiments, the pivot 20 may include apertures 46 defined by the flanges 44. The pivot 20 may further include a tube 48 extending between the apertures 44. The tube 48 may be secured to the flanges 44, e.g., by means of welds. In some embodiments, bearings 50 may insert within one or both of the apertures 46 and the tube 48. The bearings 50 may be journal bearings formed of low friction material, ball bearings, bushings, or any other type of bearing. A pivot pin 52 may be placed between the apertures 38 after being inserted through apertures 46, tube 48, and bearings 50 in order to pivotally secure the upper mount 16 to the lower mount 18. Fasteners 54 may secure to the pivot pin 52 and retain the pivot pin 52 in engagement with the upper and lower mounts 16, 18. In the illustrated embodiment, the fasteners 54 are bolts engaging interior threads defined by the pivot pin 52. However, other securement means are possible, such as exterior threads on the pivot pin 52 engaging a fastener 54 embodied as a nut. In other embodiments, other securement means may be used. The illustrated implementation of the pivot 20 is one example. Various other methods for pivotal securement may also be used. For example, separate pins may pivotally secure opposing sides of the upper and lower mounts 16, 18 to one another.

A resilient pad 56 may be positioned between the upper and lower mounts 16, such as between the plate 34 and the plate 42. For example, a resilient pad may be formed of a resilient polymer that is able to resiliently deform in response to compression between the plates 34, 42. For example, the resilient pad 56 may be formed of rubber or some other polymer having sufficient elasticity. For example, the resilient pad 56 may include a polymer that has a modulus of elasticity of between 0.01 and 0.3 GPa and, preferably between 0.02 and 0.2 GPa. In the illustrated embodiment, only one resilient pad 56 is used that is located exclusively on one side of the pivot 20. In the illustrated embodiment, the axis of rotation of the spindle 12 is positioned between the stop flange 40 and the resilient pad 56 along the longitudinal direction 28.

In the illustrated embodiment, the pad 56 secures to the lower mount. For example, the pad 56 may define an aperture 58 and the plate 42 may define an aperture 60. In some embodiments, the wheel flanges 24 may secure to a center plate 62 that is secured to the plate 42, such as by means of welds. The aperture 60 may extend through the center plate 62 as well. In other embodiments, the flanges 24 secure to the plate 42 directly. A fastener 64, such as a threaded fastener, may pass through the aperture 60 and into the aperture 58 of the pad 56 in order to secure the pad 56 to the lower mount 18. The aperture 60 may be include threads engaging threads of the fastener 64. The fastener 64 preferably passes only partially through the pad 56 in order to permit compression of the pad 56. In other embodiments, the pad 56 may secure to the lower mount 18 by means of adhesives or some other means. In still other embodiments, the pad 56 may secure to the plate 34 of the upper mount 16 by means of a fastener 64, adhesive, or some other retaining means. It could simply be held captive with the arrangement of the plates and flanges.

The flanges 24 may define apertures 66 for receiving the wheel axle 22. The axle 22 may further pass through a sleeve 68 inserted through the wheel 14. Likewise, bearings 70 of any suitable type may be positioned on either side of the wheel 14 for facilitating rolling of the wheel 14. A fastener 72 may secure to the axle 22 and retain the axle in engagement with the wheel 14 and flanges 24. The illustrated securement of the wheel 14 to the lower mount is only illustrative. Any means for mounting a wheel to a caster or other structure as known in the art may be used.

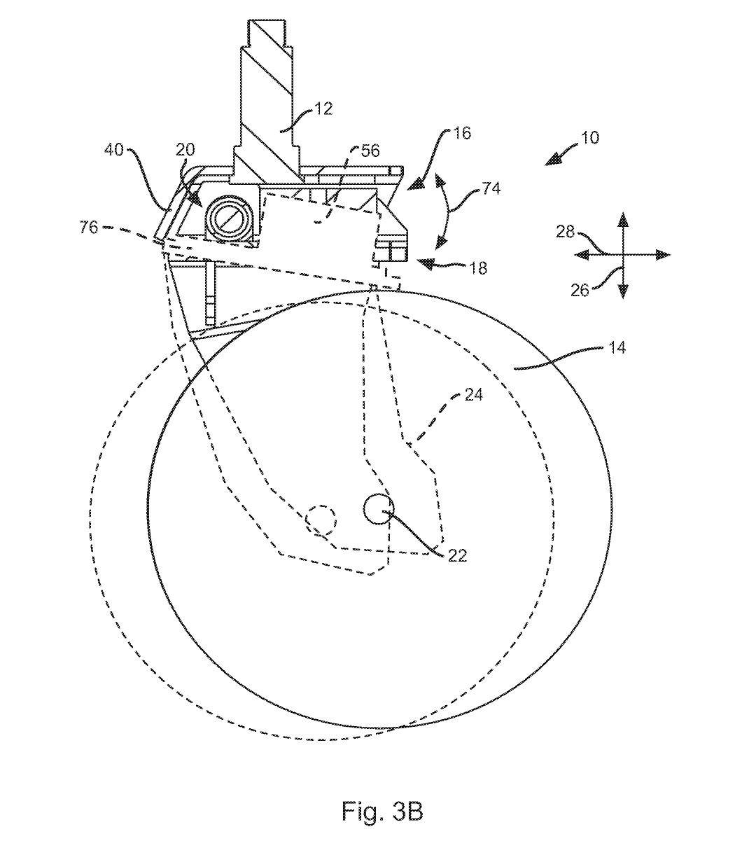

FIGS. 3A and 3B illustrate the method of operation of the caster assembly 10. Referring specifically to FIG. 3A, during typical movement, the axle 22 will be behind the spindle 12 along the direction of travel of the caster assembly 10 substantially parallel to the longitudinal direction 28. Accordingly, in response to a bump, the wheel 14 will be urged to rotate counter clockwise in rotational direction 74 about the pivot 20 for the orientation shown in FIG. 3A. As shown by the dotted representation 76 of the lower mount 18, the mount 18 pivots toward the upper mount 16 thereby compressing the resilient pad 56. The resiliency and any damping of the resilient pad 56 thereby provide shock absorbance.

Referring specifically to FIG. 3B, in some instances the lower mount 18 may rotate in a clockwise direction in rotational direction 74 with reference to the orientation of FIG. 3B as shown by the dotted representation 76. This may be in response to recoil of the resilient pad 56 or due to the axle 22 being located forward of the spindle 12 along a direction of travel, which may occur occasionally. Accordingly, the stop flange 40 may be operable to prevent rotation of the lower mount 18 in the clockwise direction past a stop position. For example, as shown by the dotted representation 76 of the lower mount 18, the lower mount 18 will abut the stop flange 40 rather than continue to rotate in response to a torque applied to the lower mount 18.

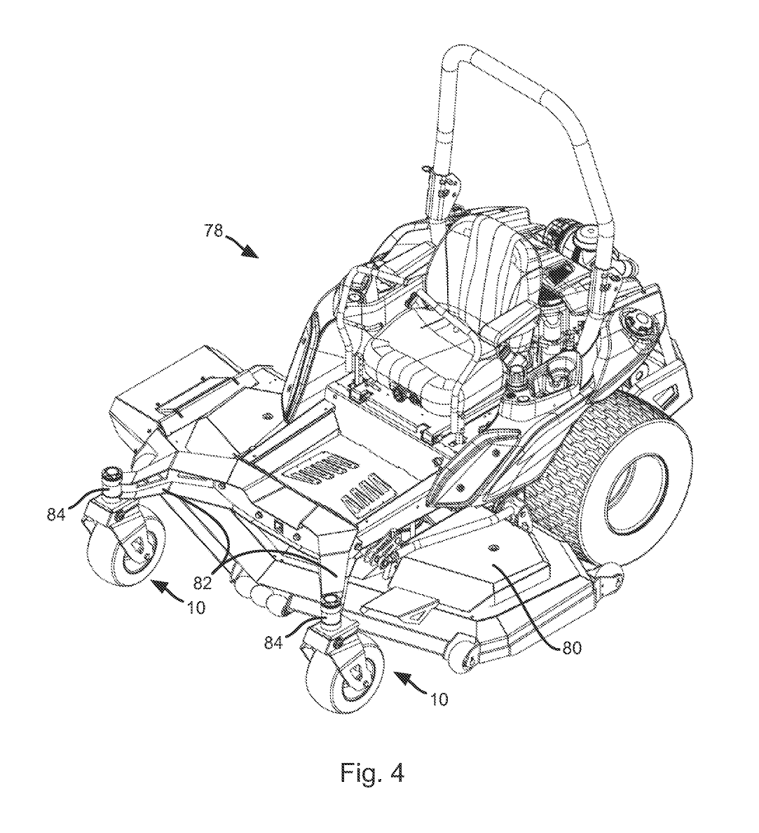

Referring to FIG. 4, the caster assembly 10 as described herein may be incorporated into a lawnmower 78. As known in the art, a lawnmower 78 may include a deck 80 that covers the lawnmower blades and is typically suspended beneath the chassis of the lawnmower 78, such as by means of frame members 82. The deck is supported by the chassis, which is in turn is supported at the front by one or more caster assemblies 10, such as caster assemblies 10 secured to spindle mounts 84 that engage the spindles of the caster assemblies 10 or otherwise pivotally mount to the caster assemblies 10.

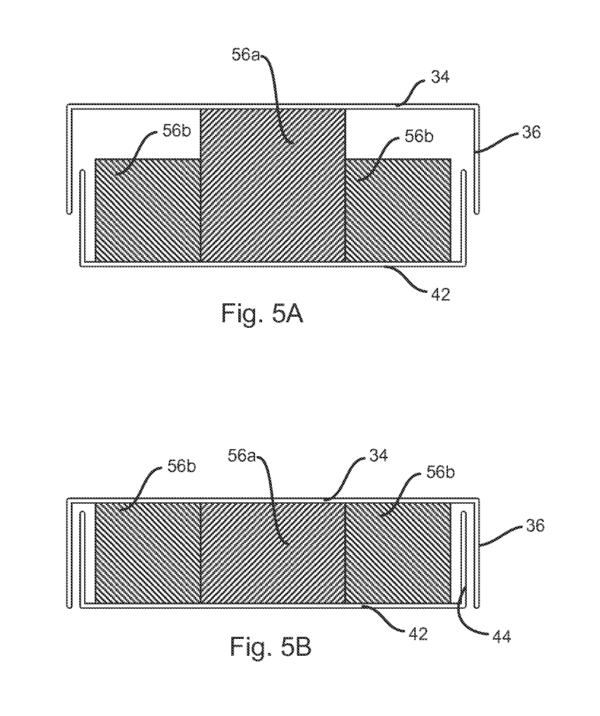

Referring to FIGS. 5A and 5B, a composite pad or variously shaped pad may alternatively be used that provides a dual rate spring and/or damping. For example, a progressive rate spring can essentially be created by having a portion of a pad that projects beyond the main body of the pad such that it can be compressed at a lower spring rate. Once the smaller portion is compressed, further movement has to compress the larger pad, thus increasing the spring rate.

For example, as shown in FIG. 5A, the pad 56 may include one or more separate pieces or portions (56a, 56b) having different heights. In the illustrated embodiment, a central portion 56a has an undeformed height extending between the central plates 34, 42 that is larger than the undeformed heights of portions 56b located on either side of the central portion 56a. Alternatively, the lateral portions 56b may have larger heights. The portions 56a, 56b may be monolithically formed having the illustrated configuration or be separate pieces that are or are not secured to one another. The portions 56a, 56b may secure to either the upper plate 34 or the lower plate 42 by means of any of the securement means noted above with respect to the pad 56. The portions 56a, 56b may be rectangular in shape, circular (i.e. a revolution of the illustrated cross sections such that a circular portion 56a is encircled by a shorter ring 56b), triangular, pyramidal, or conical. Other three dimensional shapes may be used depending on the stiffness of the material as well as the overall size and desired suspension spring rate and damping.

As shown in FIG. 5B, upon compression due to relative pivoting movement of the plates 34, 42, the higher portion 56a is compressed first to a point that all three portions 56a, 56b are engaged by both the upper and lower plates 34, 42. Where the central portion 56a has a spring rate Kₐ and the lateral portions 56b have spring rates K_{b}, the combined spring rate once the configuration of FIG. 5B is reached will be Kₐ+2K_{b}. The configuration of FIGS. 5A and 5B therefore advantageously provide a progressive spring rate that increases with compressive displacement of the plates 34, 42. Of course, the lateral portions 56b may have different spring constants from one another such that the effective spring constants is the sum of three unique spring constants.

In a more general case, one or more taller portions will give the combined pad a first spring constant for a first portion of the compressive displacement of the plates 34, 42. For a second portion of the compressive displacement of the plates 34, 42, the spring constant will be the first spring constant plus the sum of the spring constants of one or more shorter portions. Although only two heights are shown in FIG. 5A, multiple portions with three or more different heights may also be used to achieve a different progressive spring rate.

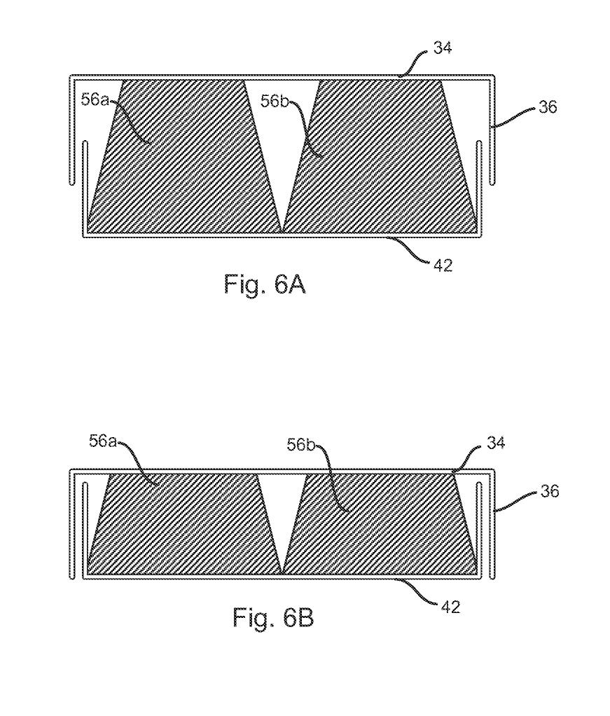

Referring to FIGS. 6A and 6B, in some embodiments a spring constant that varies by displacement may be achieved by means of one or more pads 56a, 56b having a trapezoidal cross section. The pads 56a, 56b may have a constant trapezoidal cross section along a length thereof (perpendicular to the page) or may have a frusto-conical shape (e.g., revolution of the illustrated cross section). As shown in FIG. 6B, as the pads 56a, 56b are compressed the effective width of the pads increases thereby increasing the spring rate of the springs. A cylindrical pad will expand upon compression. However, the trapezoidal cross section increases the effective expansion of the width of the pad 56a, 56b with compression.

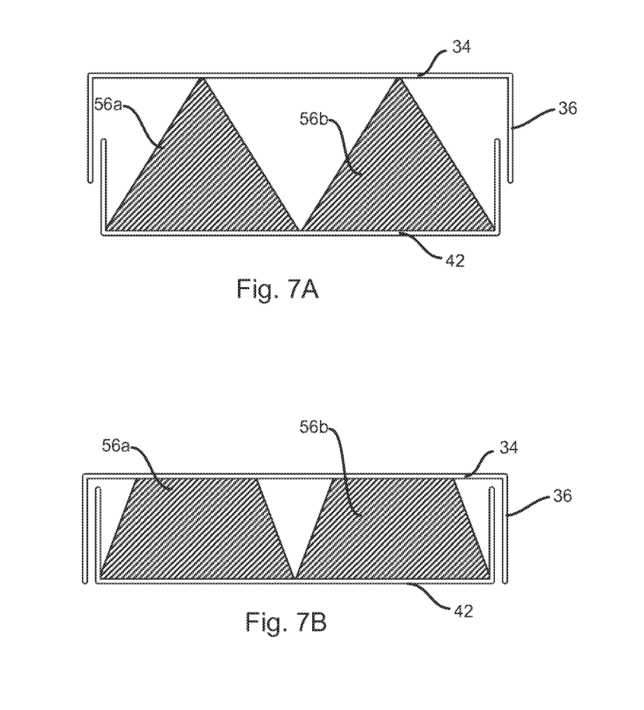

Referring to FIGS. 7A and 7B, in yet another embodiment, one or more pads 56a, 56b may have a triangular cross section that is either wedge shaped or conically shaped. As for the embodiment of FIGS. 6A and 6B, as the pads 56a, 56b are compressed the effective widths of the pads 56a, 56b increase.

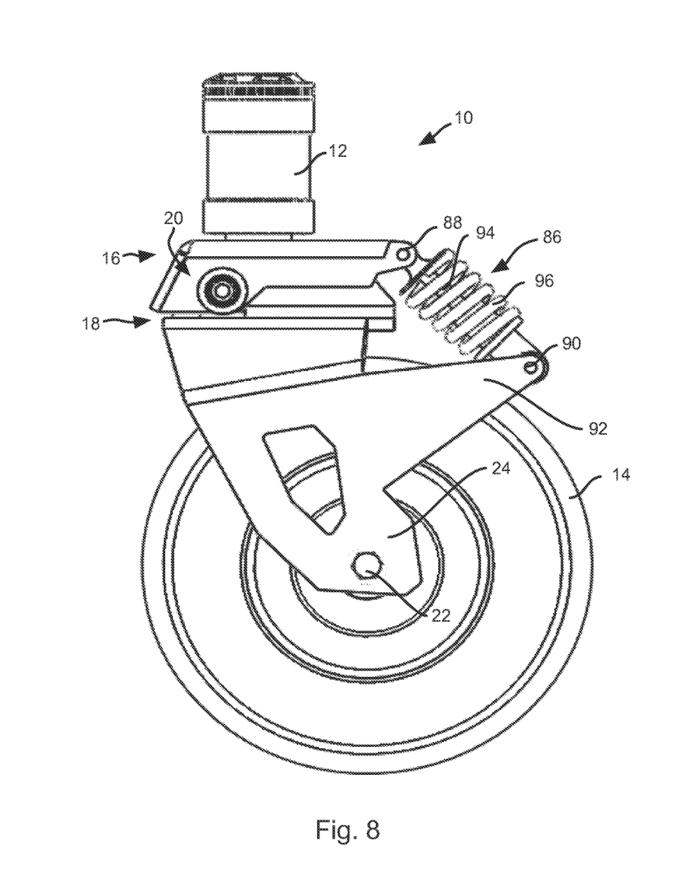

Referring to FIG. 8, in some embodiments a shock absorber 86 coupling the upper mount 16 and lower mount 18 may be used in place of, or in addition to, the pads 56, or multiple pads, of the foregoing embodiments. For example, the shock absorber 86 may pivotally mount to a pivot 88 at one end secured to the upper mount 16 and an opposite end pivotally mounts to a pivot 90 secured to the lower mount 18. The shock absorber 86 may be located on an opposite side of the spindle 12 from the pivot 20 coupling the upper and lower mounts 16, 18. In the illustrated embodiment, the pivot 90 engages a protuberance 92 defined by the flange 24. The shock absorber 86 may be any shock absorber known in the art and as such may include such elements as a piston-cylinder assembly 94 incorporating hydraulic fluid for performing damping functions and an outer spring 96.

While the preferred embodiments of the invention have been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A caster assembly comprising:
an upper mount defining a spindle axis oriented substantially vertically, the upper mount configured to rotatably mount to a chassis of a mower;
a lower mount rigidly and pivotally mounted to the upper mount and rotatable about a pivot axis, the pivot axis being substantially perpendicular to the spindle axis;
a wheel pivotally secured to the lower mount and rotatable about a wheel axis, the wheel axis being offset from the spindle axis along a longitudinal direction perpendicular to the spindle axis and the wheel axis; and
a resilient member positioned between the upper mount and the lower mount.

2. The caster assembly of claim 1, wherein the wheel axis is parallel to the pivot axis.

3. The caster assembly of claim 2, wherein the pivot axis is offset from the spindle axis along the longitudinal direction.

4. The caster assembly of claim 2, wherein the pivot axis is offset from the spindle axis along the longitudinal direction such that the spindle axis is positioned between the pivot axis and the wheel axis.

5. The caster assembly of claim 4, wherein the wheel axis is offset from the spindle axis a greater amount than the pivot axis.

6. The caster assembly of claim 1, wherein the upper mount includes a first plate having first flanges extending therefrom and the lower mount includes a second plate oriented substantially parallel to the first plate when the resilient member is undeformed, the second plate having second flanges extending therefrom, the first flanges being pivotally connected to the second flanges.

7. The caster assembly of claim 6, wherein the resilient member is retained adjacent the second plate.

8. The caster assembly of claim 6, wherein the lower mount includes a third plate having third flanges extending downwardly therefrom, the third plate being fastened to the second plate and the wheel being pivotally secured between the two flanges.

9. The caster assembly of claim 1, wherein the resilient member is a resilient polymer.

10. The caster assembly of claim 1, wherein the resilient member has a round cross-section.

11. The caster assembly of claim 1, wherein the resilient member has a narrow end in engagement with one of the upper and lower mounts and a wide end in engagement with the other of the upper and lower mounts.

12. The caster assembly of claim 1, wherein the resilient member includes a plurality of portions having at least two different heights such that one or more first portions of the plurality of portions engage the upper and lower mounts for a greater extent of pivoting movement of the upper and lower mount than second portions of the plurality of portions.

13. A caster assembly comprising:
an upper mount defining a spindle axis oriented substantially vertically, the upper mount configured to rotatably mount to a chassis of a mower;
a lower mount pivotally mounted to the upper mount and rotatable about a pivot axis, the pivot axis being substantially perpendicular to the spindle axis;
a wheel pivotally secured to the lower mount and rotatable about a wheel axis parallel to the spindle axis, the wheel axis being offset from the spindle axis along the longitudinal direction such that the spindle axis is positioned between the pivot axis and the wheel axis; and
a resilient member positioned between the upper mount and the lower mount.

14. The caster assembly of claim 13, wherein the pivot axis is offset from the spindle axis along a longitudinal direction perpendicular to the spindle axis and pivot axis, and wherein the wheel axis is offset from the spindle axis a greater amount than the pivot axis.

15. The caster assembly of claim 13, wherein the upper mount includes a first plate having first flanges extending therefrom and the lower mount includes a second plate directly opposed to the first plate when the resilient member is undeformed, the second plate having second flanges extending therefrom, the first flanges being pivotally connected to the second flanges.

16. The caster assembly of claim 15, wherein the resilient member is retained between the first and second plates.

17. The caster assembly of claim 15, wherein the upper mount further includes a stop flange extending downwardly from the first plate, the stop flange being substantially perpendicular to the first flanges.

18. The caster assembly of claim 17, wherein the spindle axis is positioned between the stop flange and the resilient member.

19. The caster assembly of claim 13, wherein the resilient member is a resilient polymer.
